(19) United States
(12) Patent Application Publication
(10) Pub. No.: US 2018/0153185 A1
(43) Pub. Date: Jun. 7, 2018

(54) SWEETENED CONDENSED CREAMER

(71) Applicant: FMC Corporation, Philadelphia, PA (US)

(72) Inventors: Cecilia Ng, Singapore (CN); Cailing Ang, Singapore (CN)

(21) Appl. No.: 15/578,825

(22) PCT Filed: Jun. 2, 2016
(86) PCT No.: PCT/US16/35375

§ 371 Date: Dec. 1, 2017

Related U.S. Application Data
(60) Provisional application No. 62/171,500, filed on Jun. 5, 2015.
(60) Provisional application No. 62/199,604, filed on Jul. 31, 2015.

(51) Int. Cl. A23C 11/04; A23L 29/262; A23L 29/10

(52) U.S. Cl. CPC A23C 11/04; A23L 29/262; A23V 2250/51082; A23V 2002/00; A23L 29/10

(57) ABSTRACT

A sweetened condensed creamer comprising: a) a hydrocolloid comprising non-coprocessed carboxymethylcellulose; b) an emulsifier; b) a protein; c) a fat; d) a sweetener; e) optionally a dispersant; and f) water. The use of non-coprocessed carboxymethylcellulose as all or a portion of the hydrocolloid component provides unexpectedly desirable storage stability in that it desirably reduces the viscosity increase during storage, relative to that observed in conventional formulations of sweetened condensed creamers which comprise only coprocessed carboxymethylcellulose.

### CROSS-REFERENCE

This application claims the benefit under 35 U.S.C. 119(e) to: U.S. Application Ser. No. 62/171,500 filed Jun. 5, 2015; and U.S. Application Ser. No. 62/199,604, filed Jul. 31, 2015.

### FIELD OF THE INVENTION

The present invention is directed to a sweetened condensed creamer comprising: a) a hydrocolloid comprising non-coprocessed carboxymethylcellulose; b) a protein; c) a fat; d) a sweetener; e) optionally an emulsifier; and f) water. The use of non-coprocessed carboxymethylcellulose as all or a portion of the hydrocolloid component provides unexpectedly desirable storage stability in that it desirably reduces the viscosity increase during storage, relative to that observed in conventional formulations of sweetened condensed creamers which comprise only coprocessed carboxymethylcellulose.

### BACKGROUND OF THE INVENTION

Sweetened condensed creamers are widely used to provide whitening and sweetening to both hot and cold beverages such as coffees, teas, cocoas and the like. Sweetened condensed creamers (or “SCC” s) are high viscosity liquids, typically possessing a solids content higher than 60% by weight, and often a solids content higher than 70% by weight.

Although sweetened condensed creamers typically possess a fat content of at least about 8% by weight or more, similar to products such as sweetened condensed milks or other similar beverage creamers, SCC's vary from sweetened condensed milks and such other beverage creamers in that SCC's have a lower protein content, typically of about 5% by weight or less. As is noted in US Patent Application 2011/0293800 (Sher), avoiding or eliminating phase separation (for example, creaming, gelation, syneresis) during storage and reconstitution in beverages that include a low protein creamer—especially in hot and acidic beverages—is challenging. Sher discloses the use of a combination of an emulsifying component comprising a low HLB emulsifier and a medium HLB emulsifier in combination with a hydrocolloid component comprising microcrystalline cellulose (MCC)/carboxymethylcellulose (CMC)/alginate in order to provide physico-chemical stability for the low protein liquid creamer sweetener described therein.

Sweetened condensed creamers which employ carboxymethylcellulose only in a coprocessed form (for example, carboxymethylcellulose coprocessed with microcrystalline cellulose) have been found to exhibit a viscosity increase upon storage.

A need still exists for a sweetened condensed creamer formulation that includes carboxymethylcellulose that is stable, that is, does not exhibit an unacceptable viscosity increase and/or phase separation during storage.

### SUMMARY OF THE INVENTION

The present invention is directed to a sweetened condensed creamer comprising: a) a hydrocolloid comprising non-coprocessed carboxymethylcellulose; b) a protein; c) a fat; d) a sweetener; e) optionally a dispersant; and f) water.

The use of non-coprocessed carboxymethylcellulose as all or a portion of the hydrocolloid component provides storage stability that is both unexpected and desirable, in that it reduces the magnitude of the viscosity increase observed during storage, relative to that observed in conventional formulations of sweetened condensed creamers which comprise only coprocessed carboxymethylcellulose, so that the increase in viscosity during storage of the creamers claimed herein is at an acceptable level. Phase separation does not occur during the period of observation.

### DETAILED DESCRIPTION OF THE INVENTION

The present invention is directed to sweetened condensed creamer comprising:

a) a hydrocolloid component comprising non-coprocessed carboxymethylcellulose;

b) protein;

c) fat;

d) sweetener;

e) optionally an emulsifier; and

f) water.

As is employed herein, the term “non-coprocessed carboxymethylcellulose” refers to carboxymethylcellulose which has not been coattrited or otherwise co-processed with another substance, such as microcrystalline cellulose. As is employed herein “coprocessed carboxymethylcellulose” refers to carboxymethylcellulose which has been co-processed with another substance or material such as microcrystalline cellulose. One of ordinary skill in the art would understand the term without further elaboration. However, for guidance, and without being strictly limited by the definition provided herein, the term “coprocessed” refers to materials, including carboxymethylcellulose, that are isolated, purified, blended, attrited, ground, mixed, kneaded, dried or spray-dried, dispersed, re-dispersed, or otherwise physically, chemically, or mechanically manipulated in the presence of one or more other materials, including one or more of the other components used to formulate the sweetened condensed creamer claimed herein prior to formulation of the sweetened condensed creamers described herein.

“Non-coprocessed”, as the term is used herein, means carboxymethylcellulose that has been not been coprocessed with any other material, with the possible exception of water, prior to being combined with the other components of the sweetened condensed creamer. For the avoidance of doubt, the physical combination of the components to form the sweetened condensed creamers described herein is not considered “coprocessing” for the purposes of this application.

The behavior of non-coprocessed carboxymethylcellulose differs from that of coprocessed carboxymethylcellulose in the sweetened condensed creamer described herein insofar as the non-coprocessed carboxymethylcellulose is more effective in reducing storage instability as measured by the viscosity increase during storage of a product comprising the sweetened condensed creamers described herein.

The non-coprocessed carboxymethylcellulose employed in the practice of this invention typically has a degree of substitution (DS) between 0.4 and 1.5, and more typically has a DS of between 0.65 and 1.2. Typically, the non-coprocessed carboxymethylcellulose has a viscosity of more than 100 cps in 2% concentration as measured by Brookfield Viscometer employing an appropriate spindle.

In addition to non-coprocessed carboxymethylcellulose, the hydrocolloid component of the sweetened condensed creamer of this invention may additionally comprise another hydrocolloid, for example, one or more of cellulose, microcrystalline cellulose, coprocessed carboxymethylcellulose, carrageenan (e.g., kappa, iota), agar-agar, cornstarch, gelatin, gellan (e.g., high acyl, low acyl), guar gum, gum arabic, konjac, locust bean gum, methyl cellulose, pectin, alginate, tapioca maltodextrin, tracaganth, xanthan and modified starches. The hydrocolloid component can comprise from (1 to 100%), based on the total weight of the hydrocolloid component, of the non-coprocessed carboxymethylcellulose. Typically, non-coprocessed carboxymethylcellulose comprises at least about 10% by weight of the hydrocolloid component. In some cases, the non-coprocessed carboxymethylcellulose can comprise at least about 20%, 25%, 30%, 40% 50%, 60%, 70%, 75%, 80% or 90% of the hydrocolloid component.

In one embodiment, the hydrocolloid component comprises microcrystalline cellulose (MCC), non-coprocessed carboxymethylcellulose (“ncpCMC”) and alginate. In such embodiment, the weight ratio of MCC to ncpCMC typically ranges from 10:1 to 1:10; and the weight ratio of ncpCMC to alginate typically ranges from 50:1 to 1:10. In such embodiments, the microcrystalline cellulose may be present in the form of colloidal microcrystalline cellulose coattrited or processed with CMC or non-colloidal microcrystalline cellulose. In such embodiments, the CMC portion of the colloidal MCC is not included in the MCC:ncpCMC weight ratios cited above.

In general, the hydrocolloid component of the sweetened condensed creamer of this invention ranges from 0.01 to 0.50 percent by weight; and is typically between 0.05 and 0.2 weight percent.

The sweetened condensed creamer of this invention comprises one or more sweeteners, which may be “high calorie” or “low calorie” materials. When conventional sugar-type sweeteners are employed, the sweetened condensed creamer typically comprises from 10 to 60 percent by weight, more typically of from 40 to 60 percent by weight of one or more sweeteners. In embodiments which are directed to lower calorie sweetened condensed creamers, the sweetened condensed creamer typically comprises from 0.1 to 40.0 percent by weight, more typically of from 1.0 to 30.0 percent by weight of one or more sweeteners. In certain embodiments, these sweeteners comprise one or more mono-saccharides, such as glucose and fructose; di-saccharides such as lactose, maltose, and sucrose; and oligosaccharides including fructo-oligosaccharides, such as fructans, or galacto-oligosaccharides, or manno-oligosaccharides, or galactomanno-oligosaccharides, or gluco-oligosaccharides, such as maltodextrins or cyclodextrins or cellodextrins. The sweetener component can also comprise sugarless sweeteners including sugar alcohols such as maltitol, xylitol, sorbitol, erythritol, mannitol, isomalt, lactitol, hydrogenated starch hydrolysates, and the like, alone or in combination.

The sweetened condensed creamer of this invention typically comprises from 0.01 to 40.0 percent by weight, more typically of from 5.0 to 15.0 percent by weight of one or more fats. Such fats may be either solid or liquid at room temperature (23° C.), i.e. the term fat as used herein includes fats that are liquid at room temperature (commonly referred to as “oils”) and fats that are solid at room temperature (commonly referred to as “fats”). Typically, such fats are in the form of vegetable oils, although animal fats, such as milk fat, may be also be employed. Preferred fats include soybean oil, coconut oil, palm oil, palm oil fractions, cottonseed oil, canola oil, olive oil, sunflower oil, high oleic sunflower oil, safflower oil or a combination thereof. The vegetable oil(s) can include partially or wholly hydrogenated oils, alone or in combination.

The sweetened condensed creamer of this invention typically comprises from 0.01 to 10.0 percent by weight, more typically of from 0.5 to 4.0 percent by weight of one or more proteins. Preferred sources for the protein which may be used in the present invention include: (a) dairy protein sources, such as whole milk, skim milk, milk solids, non-fat milk, and mixtures thereof; whey permeate, sweet whey powder, demineralized whey, whey protein isolate and whey protein concentrates, caseinate, and mixtures thereof; (b) vegetable proteins and vegetable protein sources such as soy, wheat, rice, canola, potato, corn, buckwheat, pea and mixtures thereof; and (c) animal sources of protein including gelatin or egg proteins. The protein may be present as the isolated protein, as a protein concentrate or as a protein hydrolysate.

When present, the emulsifier component of the sweetened condensed creamer of this invention typically comprises one or more of lecithin; hydroxylated lecithin; mono, di, or polyglycerides of fatty acids such as glyceryl mono- and distearate (GMS) and polyglycerol esters of fatty acids (PGE) such as triglycerol monostearate (TGMS); polyoxyethylene ethers of fatty esters of polyhydric alcohols such as the polyoxythylene ethers of sorbitan monostearate (Tween 60) or the polyoxyethylene ethers of sorbitan distearate; fatty esters of polyhydric alcohols such as sorbitan monostearate; mono- and diesters of glycols such as propylene glycol monostearate and propylene glycol monopalmitate; sucrose esters; and the esters of carboxylic acids such as lactic, citric, and tartaric acids with the mono- and diglycerides of fatty acids, such as glycerol lacto palmitate and glycerol lacto stearate.

Typically, the emulsifier component of the sweetened condensed creamer of this invention ranges from 0.01 to 0.5 percent by weight; and is more typically between 0.05 and 0.25 weight percent.

In addition to water, the SCCs of this invention may further comprise additional ingredients such as flavors, colorants, preservatives, vitamins and the like.

The sweetened condensed creamers of this invention may be prepared by adding the components to water under agitation, followed by heat treatment, homogenization, pasteurization and filling aseptic containers under aseptic conditions. Typically, after the pasteurization step a deaeration process is carried out in vacuum, with lactose is added to grain for seeding.

The sweetened condensed creamers of this invention exhibit desirable storage stability, coupled with desirable dispensability in hot and cold beverages, as a spread or even in cooking. A sweetened condensed creamer with desirable storage stability should exhibit a lack of phase separation over the period of observation and measurement. While an initial viscosity increase is expected and is typical within the first two weeks, the initial viscosity increase should start to plateau after the initial period of observation and measurement. In the sweetened condensed creamers described herein, the rate of viscosity increase is reduced compared with the rate of viscosity increase using coprocessed CMC, which indicates that using non-coprocessed CMC produces products having improved storage stability. This reduced rate of viscosity increase is surprising. Viscosity measurements are done using a consistometer, which measures viscosity as correlated to the distance a fluid travels within a certain timed period. Typically, an initial increase in viscosity after formulation of the sweetened condensed creamer is considered normal. Compared with an initial consistometer measurement after one day of storage, the consistometer measurement of a sweetened condensed creamer typically gets smaller (indicating increased viscosity) after 1 week of storage. Measured any time after the first week of storage, the viscosity of the sweetened condensed creamers prepared as described herein do not exhibit a consistometer measurement that decreases by more than about 1.5 cm at the 30 seconds time interval during the rest of the product shelf life of the sweetened condensed creamer. Overall, the consistometer measurement of a sweetened condensed creamer prepared as described herein does not decrease by more than about 4.5 cm, measured 1-month after initial preparation, compared with an initial measurement after 1-day of storage. Preferably, after being stored for 1 month the consistometer measurement of the sweetened condensed creamer should not decrease by more than about 3.5 cm from the initial measurement at 1 day storage, and more preferably not by more than about 2.5 cm. It can be desirable that the consistometer measurement taken after 1-month storage should not differ by more than about 4.5 cm compared with a reading taken after 1-day storage and, in addition, not differ by more than about 1.5 cm compared to a consistometer reading after 1-week of storage. Further, it can be desirable that the consistometer reading taken after 1-month of storage should not differ by more than about 1.0 cm from a measurement taken after 1-week of storage.

### EXAMPLES

### Example 1, 2, 3, 4 and Comparative Experiment A

In order to compare sweetened condensed creamers of this invention (Examples 1-4) with a commercial formulation comprising Avicel-Plus® GP 3522 (a coprocessed MCC/CMC and alginate blend) (Comparative Experiment A), five formulations were produced comprising the components in the weight percent listed in Table 1.

TABLE 1

| Ingredient | | | | | Comparative |
|---|---|---|---|---|---|
| (Weight Percent) | Example 1 | Example 2 | Example 3 | Example 4 | Experiment A |
| Avicel-Plus ® GP 3522 | — | — | — | — | 0.20 |
| CMC 7MF2 | 0.05 | 0.10 | 0.15 | 0.20 | — |
| Sugar | 46.80 | 46.80 | 46.80 | 46.80 | 46.80 |
| Maltodextrin | 7.00 | 7.00 | 7.00 | 7.00 | 7.00 |
| Disodium phosphate | 0.10 | 0.10 | 0.10 | 0.10 | 0.10 |
| Lactose | 0.05 | 0.05 | 0.05 | 0.05 | 0.05 |
| Skimmed Milk Powder | 6.00 | 6.00 | 6.00 | 6.00 | 6.00 |
| Whey Powder | 3.00 | 3.00 | 3.00 | 3.00 | 3.00 |
| Vegetable Fat | 10.60 | 10.60 | 10.60 | 10.60 | 10.60 |
| Water | 26.40 | 26.35 | 26.30 | 26.25 | 26.25 |

The formulation comprising only coprocessed carboxymethylcellulose (Comparative Experiment A) or comprising non-coprocessed carboxymethylcellulose (Examples 1 to 4) was blended with a portion of the sugar to form a pre-blend; and the pre-blend added in water at 70° C. to form a base solution. A blend of whey powder, disodium phosphate and skim milk powder added to the base solution. This mixture was stirred for 5 minutes and transferred to a pasteurization pot. The remaining sugar and maltodextrin were blended and added; and the mixture stirred for 5 minutes using paddle stirrers. The vegetable fat was pre-melted and then added to the mixture which was stirred for an additional 5 minutes. The mixture was then preheated to 70° C.; homogenized at 100 bars; and pasteurized at 80-82° C. for 10 minutes. The mixture was transferred to a Stephan universal machine and vacuumed to 90%; and cooled to 30° C.; the lactose was added and the mixture was stirred for 2 minutes before being further cooled to 25° C. and again vacuumed to 90%. The final product was then packaged into glass bottles for storage and evaluation.

Samples of each of the formulations were tested for their visual and sensory appearance alone and when added to coffee (stirred and non-stirred); both initially and after storage at 37° C. for one month. The performance of the samples with non-coprocessed CMC was comparable to that of the premium commercial product. No phase separation was observed.

The viscosity of each of the samples was measured, for initial viscosity after one day's storage, one week's storage and after one month's storage, using a standard Bostwick consistometer (Model No. 249250000) available from CSC Scientific. The flow measurement chamber of the consistometer had dimensions (height×length×width) of 3.5 cm×5.0 cm×5.0 cm. The sample was poured into the consistometer and held in a compartment of the consistometer by a gate. A timer was started when the gate of the consistometer was released to allow flow of the sample into the flow measurement chamber. The tests were conducted at ambient (room) temperature. The distance (in cm) travelled by the leading edge of the product in the flow measurement chamber was recorded at the 30 seconds time interval, to the nearest 0.1 cm. The results of such viscosity testing (in cm) are presented in Table 2 below.

TABLE 2

| Example or | Viscosity | Viscosity | Viscosity |
|---|---|---|---|
| Comparative | After One | After One | After One |
| Experiment | Day Storage | Week Storage | Month Storage |
| A | 16.3 | 13.1 | 11.5 |
| 1 | 18.8 | 16.3 | 16.3 |
| 2 | 16.9 | 15.1 | 15.7 |
| 3 | 16.8 | 14.5 | 14.2 |
| 4 | 15.7 | 14.3 | 13.6 |

* Viscosity testing measured based on consistometer flow, with a smaller number reflecting a more viscous product, and vice versa.

The viscosities of samples comprising non-coprocessed carboxymethylcellulose (Examples 1-4) were found to level off within one month—that is, the consistometer measurement at one month was found to be within 1 cm of the consistometer reading at week 1; in contrast, the viscosity of the sweetened condensed creamer comprising coprocessed carboxymethylcellulose exhibited increased viscosity resulting in an increased consistometer measurement of more than 2 cm after the same one month storage period.

What is claimed is:

1. A sweetened condensed creamer comprising:
a) a hydrocolloid component comprising non-coprocessed carboxymethylcellulose;
b) protein;
c) fat;
d) sweetener
e) optionally an emulsifier; and
f) water;

2. The creamer of claim 1 wherein the hydrocolloid comprises between 0.01 and 0.5 weight percent of the total weight of the creamer.

3. The creamer of any of the preceding claims wherein the hydrocolloid further comprises one or more of cellulose, microcrystalline cellulose, coprocessed carboxymethylcellulose, carrageenan, agar-agar, cornstarch, gelatin, gellan, guar gum, gum arabic, kojac, locust bean gum, methyl cellulose, pectin, alginate, tapioca maltodextrin, tracaganth, xanthan and modified starches.

4. The creamer of claim 3 wherein non-coprocessed carboxymethylcellulose comprises at least 10% by weight of the hydrocolloid component.

5. The creamer of any of the preceding claims wherein the non-coprocessed carboxymethylcellulose has a degree of substitution between 0.4 and 1.5.

6. The creamer of claim 5 wherein the non-coprocessed carboxymethylcellulose has a degree of substitution between 0.65 and 1.2.

7. The creamer of claim 3 wherein the hydrocolloid comprises a mixture of microcrystalline cellulose, non-coprocessed carboxymethylcellulose and alginate.

8. The creamer of claim 7 wherein the weight ratio of microcrystalline cellulose to non-coprocessed carboxymethylcellulose is from 1:10 to 10:1; and the weight ratio of non-coprocessed carboxymethylcellulose to alginate is from 50:1 to 10:1.

9. The creamer of any of the preceding claims wherein the protein comprises between 0.01 and 10.0 weight percent of the total weight of the creamer.

10. The creamer of any of the preceding claims wherein the protein comprises one or more members selected from the group consisting of milk proteins: whey protein isolate and whey protein concentrates, caseins, and mixtures thereof; vegetable proteins and vegetable protein sources such as soy, wheat, rice, canola, potato, corn, buckwheat, pea and mixtures thereof; and animal sources of protein including gelatin or egg proteins.

11. The creamer of any of the preceding claims wherein the fat comprises between 0.01 and 40.0 weight percent of the total weight of the creamer.

12. The creamer of any of the preceding claims wherein the fat comprises one or more members of the group consisting of milk fats, soybean oil, coconut oil, palm oil, palm oil fractions, hydrogenated palm kernel oil, cottonseed oil, canola oil, olive oil, sunflower oil, high oleic sunflower oil, and safflower oil.

13. The creamer of any of the preceding claims wherein the sweetener comprises between 10 and 60 weight percent of the total weight of the creamer.

14. The creamer of any of the preceding claims wherein the sweetener comprises a sugarless sweetener.

15. The creamer of claim 14 wherein the sweetener comprises from 0.1 to 40.0 percent by weight of the total weight of the creamer.

16. The creamer of any of the preceding claims wherein the sweetener comprises one or more members of the group consisting of monosaccharides, di-saccharides, polysaccharides and sugarless sweeteners.

17. The creamer of any of the preceding claims wherein said sweetener further comprises an emulsifier.

18. The creamer of claim 16 wherein the emulsifier comprises between 0.01 and 0.5 weight percent of the total weight of the creamer.

19. The creamer of claim 16 wherein the emulsifier comprises one or more of lecithin; hydroxylated lecithin; mono, di, or polyglycerides of fatty acids; polyoxyethylene ethers of fatty esters of polyhydric alcohols; fatty esters of polyhydric alcohols; mono- and diesters of glycols; sucrose esters; and esters of carboxylic acids.

20. The creamer of any of the preceding claims wherein said creamer further comprises one or more components selected from the group consisting of flavors, colorants, preservatives, and vitamins.
